(19) United States
(12) Patent Application Publication
(10) Pub. No.: US 2008/0222072 A1
(43) Pub. Date: Sep. 11, 2008

(54) Analysing Documents

(75) Inventors: Lavrans Lovlie, Oslo (NO); Stephen John Doran, Long Sutton (GB)

Correspondence Address: RICHARD M. GOLDBERG, 25 EAST SALEM STREET, SUITE 419, HACKENSACK, NJ, 07601, US

(73) Assignee: NORWICH UNION INSURANCE LIMITED, Norwich (GB)

(21) Appl. No.: 11/947,136

(22) Filed: Nov. 29, 2007

(30) Foreign Application Priority Data
Nov. 29, 2006 (GB) 06 23 814.1

(51) Int. Cl. G06N 5/02

(52) U.S. Cl. 706/47

(57) ABSTRACT

The text of a document is received and stored, it is analysed according to predetermined rules to identify pitfalls and features of the document, and a graphic displaying the pitfalls and features is created and displayed.

### FIELD OF THE INVENTION

The present invention relates to a method of analysing the information contained within documents.

### BACKGROUND OF THE INVENTION

Many documents relating to products or services contain terms and conditions, legal wording or “fine print” that is difficult for a consumer to understand, for example contracts, insurance policy documents, banking terms and conditions, and so on. Often the fine print, if read correctly, would indicate to a consumer the quality that he could expect should he buy the related product or service. However, consumers usually neither read nor understand it.

Thus comparing legal documents such as insurance policies against each other can be confusing and complicated for non-professionals. The complexity is further deepened by other variables such as price, excesses payable and options. For example, a user seeking to insure household contents or taking out a motor insurance policy often starts with a fixed amount to be insured; for example the value of the car, but then is presented by one or more insurers with an array of options, for example price, the excess payable upon a claim, the level of cover (for example third party, fire and theft or fully comprehensive), and exclusions (for example circumstances or items not covered, like windscreen damage). In addition, the wording of the different policies will often vary in style, some of which can be confusing to people not experienced with legal documents.

As a result, in practice it is not possible for consumers to compare like with like when making a purchasing decision. Furthermore, it is easy for consumers to miss or misunderstand clauses that may not be in their best interests.

### BRIEF SUMMARY OF THE INVENTION

There is therefore provided a method of analysing a document, comprising the steps of receiving and storing the text of a document, analysing the document according to predetermined rules to identify pitfalls and features of the document and creating and displaying a graphic displaying the pitfalls and features.

### BRIEF DESCRIPTION OF THE SEVERAL VIEWS OF THE DRAWINGS

FIG. 1 shows a networked environment;

FIG. 2 shows a user at a networked terminal shown in FIG. 1;

FIG. 3 details steps carried out at the terminal shown in FIG. 2;

FIG. 4 illustrates a homepage displayed by the terminal shown in FIG. 2;

FIG. 5 illustrates a webpage showing a graphic of an insurance policy document displayed by the terminal shown in FIG. 2;

FIG. 6 illustrates a webpage showing a more detailed graphic of the insurance policy shown in FIG. 5;

FIG. 7 illustrates a webpage showing a still more detailed graphic of the insurance policy shown in FIG. 5; and

FIG. 8 illustrates a webpage showing a ranking of insurance policy documents.

### DESCRIPTION OF THE BEST MODE FOR CARRYING OUT THE INVENTION

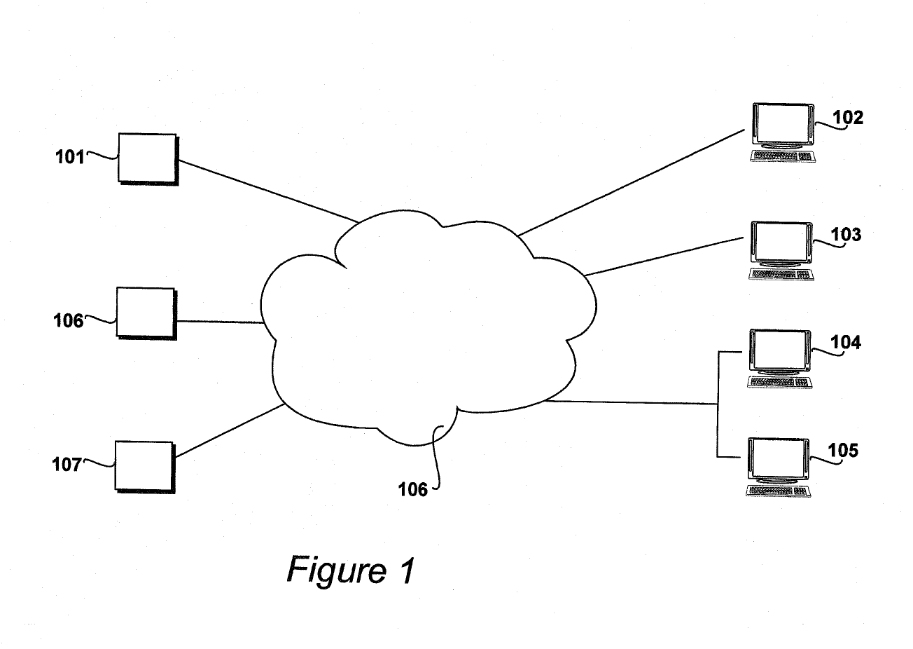

### FIG. 1

An environment in which the invention may be implemented is shown in FIG. 1. In this embodiment the documents being analysed are insurance policy documents, but it could be implemented with regard to any other kind of legal document. Server 101 stores text copies of policy documents, analyses these documents and hosts a website that presents the results of the analysis to users. The website may also store personal details of users, search online for insurance quotes and present a number of best options to a user by offsetting the price of the quote by the quality of the service.

Networked user terminals such as terminals 102, 103, 104 and 105 are connected to server 101 via the Internet 106. Servers such as 106 and 107 are also connected to the Internet. Server 106 is the server of an insurance company, while server 107 hosts other websites.

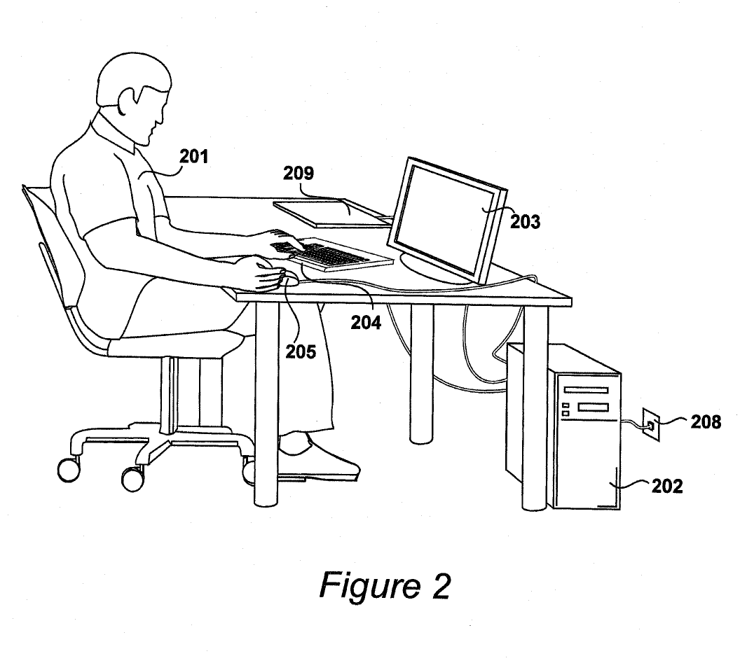

### FIG. 2

Terminal 102 is shown in FIG. 2. A user 201 is using it to analyse insurance policy documents online. Terminal 102 includes a computer 202 that includes a CPU, memory, a hard drive, a DVD-ROM drive, a graphics card, a network card, a USB interface, a modem and other interfaces. Program instructions, loaded either from the Internet or from a removable media such as a USB flash memory stick or a CD-ROM, are stored on the hard drive and processed by the CPU in order to display information via the graphics card on a visual display unit 203. Manual input is provided to the computer 202 by way of keyboard 204 and mouse 205. Connection to the Internet is provided via broadband socket 206. Scanner 207 allows the user 201 to upload electronic copies of documents to the hard drive of computer 202.

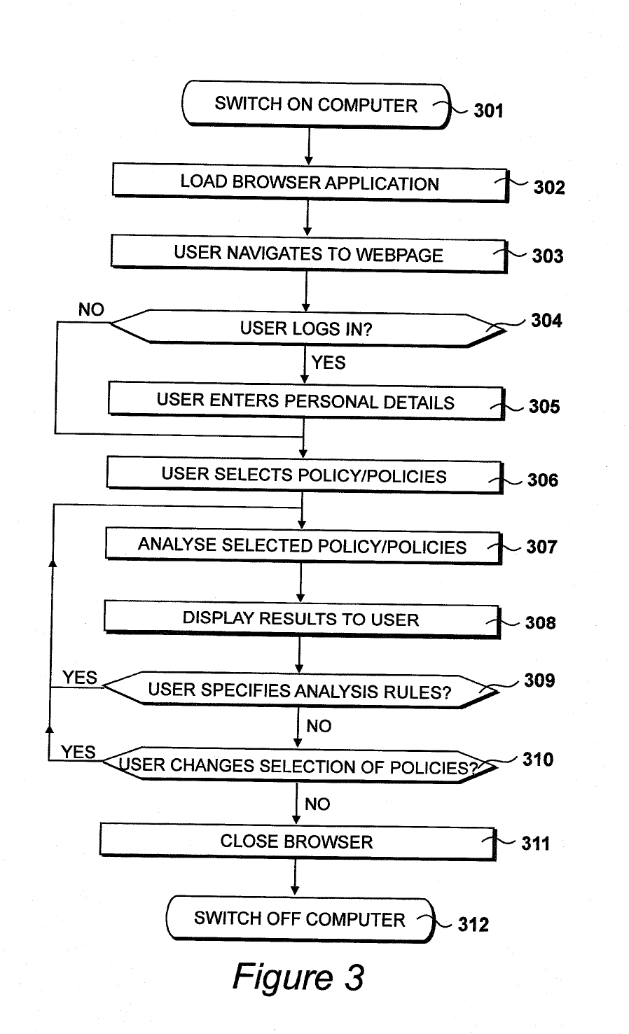

### FIG. 3

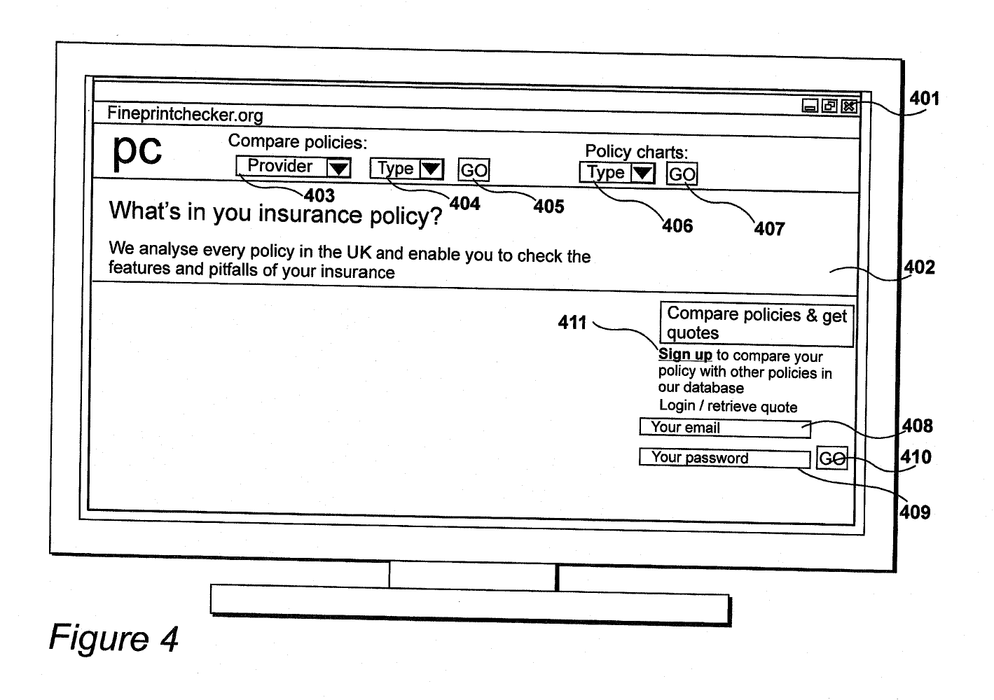

FIG. 3 shows steps taken by user 201. At step 301 he turns on the computer 202 and at step 302 he loads a browser application. At step 303 he navigates to the homepage of the website (shown in FIG. 4) and at step 304 a question is asked as to whether he logs in. If this question is answered in the affirmative then at step 305 he enters personal details. These might include, in this example, any details necessary to obtain an insurance quote, details of existing insurance, and so on. Following this step, or if the question asked at step 304 is answered in the negative, he selects one or many insurance policies to compare at step 306.

At step 307 the selected policies are analysed, or if they are already analysed cached analyses may be retrieved, and at step 308 the results are displayed to the user. At step 309 a question is asked as to whether the user specifies further analysis rules. If this question is answered in the affirmative then control is returned to step 307 and the selected policies are re-analysed. Alternatively, a further question is asked at step 310 as to whether the user has selected different policies to compare. Again, if this question is answered in the affirmative then control is returned to step 307 and the selected policies are analysed, possibly including further analysis rules specified at step 309.

At step 311 the user closes the browser application and at step 312 he switches off the computer.

### FIG. 4

Browser application 401 displaying homepage 402, displayed at step 303, is shown in FIG. 4. The homepage shows basic information, such as a selection of policy analyses. In this embodiment a user can select policies at step 306 in one of two ways. Firstly, he can select a single policy using drop-down box 403 to select an insurance company and drop-down box 404 to select an insurance type, then press button 405. Secondly, he can simply select a type from drop-down box 406 and press button 407, thus selecting all policies of that type.

A user can logon by typing his username in box 408 and password in box 409 then pressing button 410. An unregistered user may sign up by clicking on link 411 and logon once registered. If a user logs on then he will receive a more personalised experience, but much of the website is available without logging on.

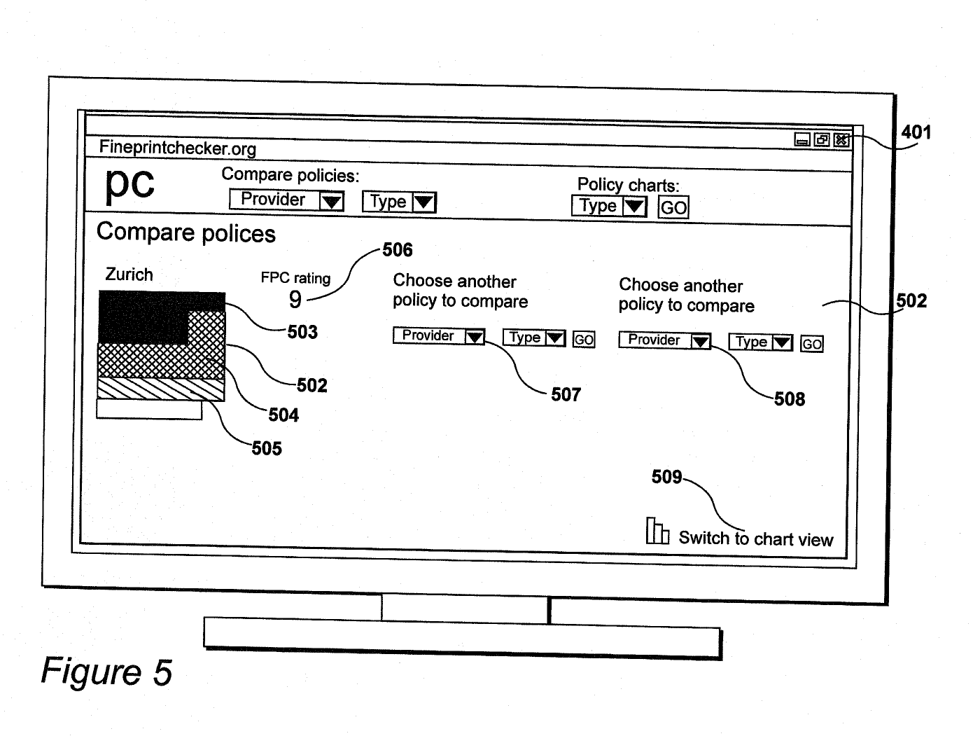

### FIG. 5

If a user selects a single policy at step 306, webpage 501 is displayed by browser application 401 at step 308. A graphic 502 of the textual layout of the policy document is shown. The graphic contains red sections, such as section 503, green sections, such as section 504, and grey sections, such as section 505. Each section is a portion of text within the document that has been analysed. Red sections are “pitfalls” that the user should be careful of, such as exceptions to insurance and conditions of insurance, except those that benefit a customer. Green sections contain “features” that the user may consider add value to the policy. Grey sections contain information that is neither a pitfall nor a feature, such as non-legal wording, company information, wording common to all policy documents and so on. These rules are appropriate for insurance policy documents, but other rules to identify pitfalls and features would be used for different kinds of legal documents.

The analysis of policy documents may be done offline, either manually by a person or automatically by a program such as a text parser, and cached for retrieval by a user, or done online automatically by a text parser.

Once analysed a policy may be scored according to the ratio of red sections to green sections. This can be done by the number of highlighted sections, the total words within the highlighted sections, and so on. Once all the policies have been scored a rating 506 indicating the policy's position compared with other policies of the same type can be given.

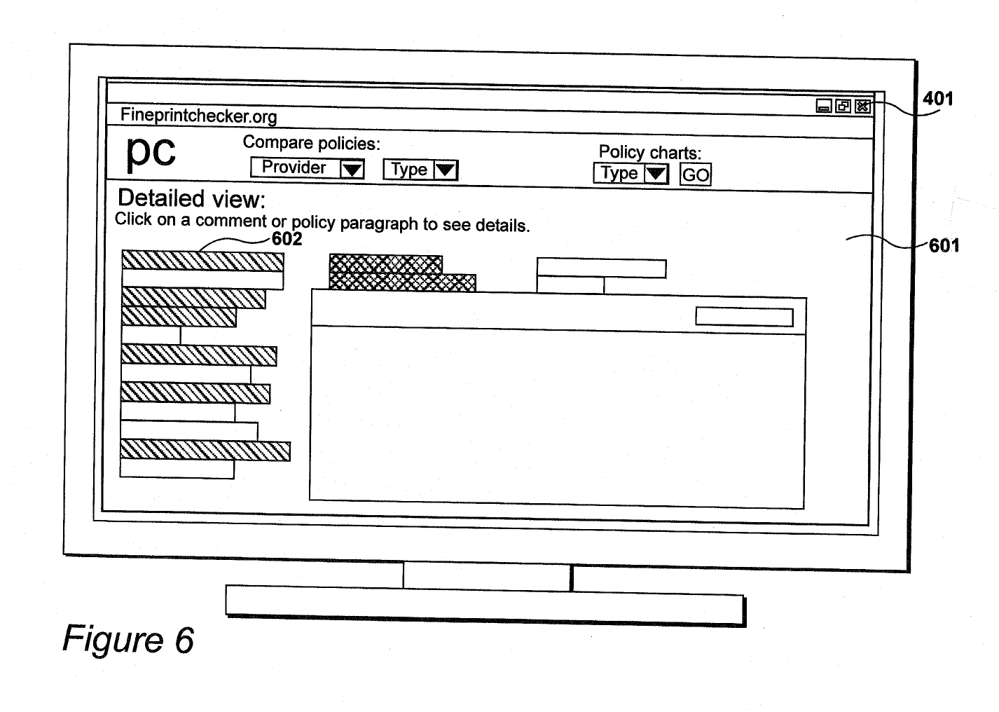

A user may select further policies to compare using boxes 507 and 508, following which the graphic and rating for the selected policy or policies are displayed similarly to graphic 502 and rating 506. Alternatively the user can view a displayed policy in more detail as shown in FIG. 6 by clicking on link 509.

### FIG. 6

A page 601 showing a more detailed view 602 of the analysed policy is displayed by browser application 401 in FIG. 6. In this view a marked section can be selected so that the user can see what the pitfall or feature is. Comments left by other users can also be seen.

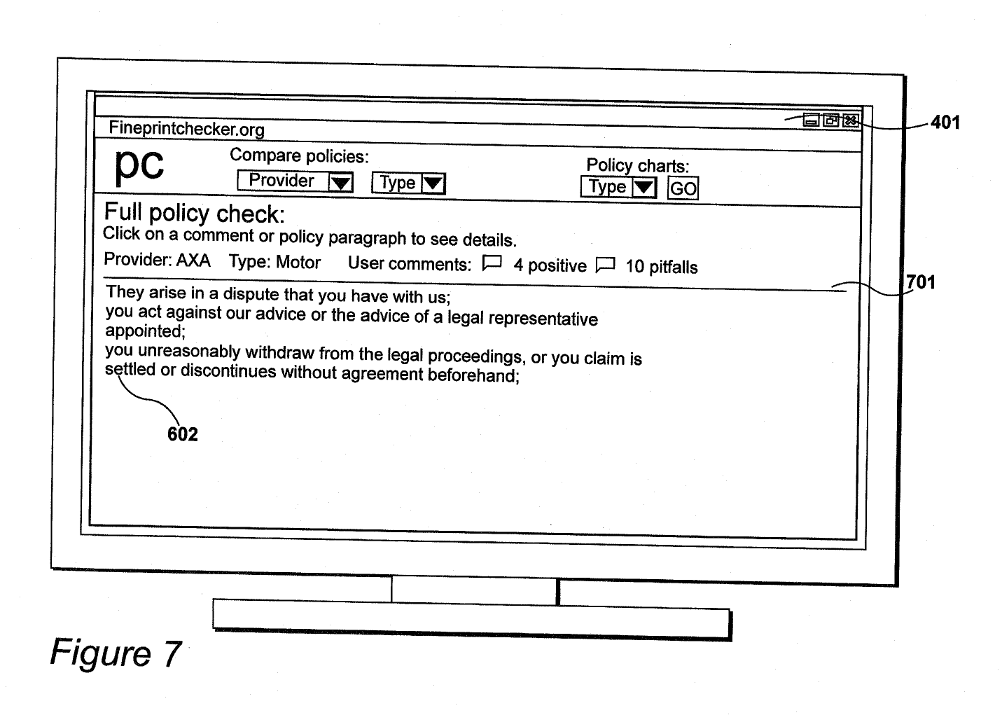

### FIG. 7

A page 701 showing a still more detailed view of the analysed policy is displayed by browser application 401 in FIG. 7. In this view the full text of a marked section is displayed, along with comments left by other users.

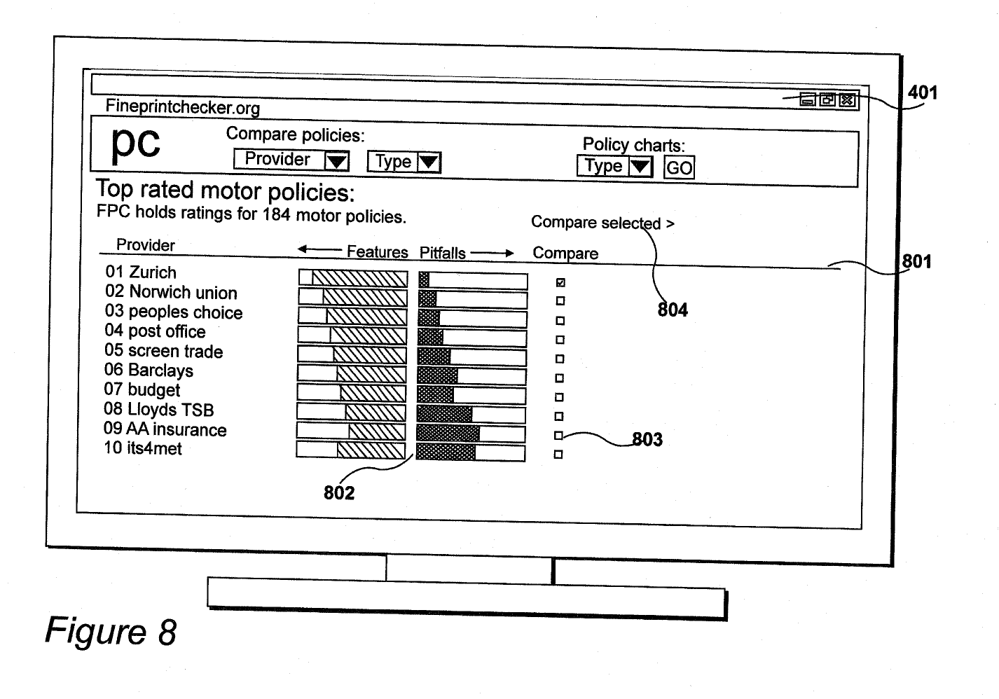

### FIG. 8

If a user selects all policies of a particular type at step 306, webpage 801 is displayed by browser application 401 at step 308. A comparison graph 802 shows the ratio of green sections to red sections for each of the analysed policy documents, and the documents are listed in order of rating, with the policy having the highest ratio of green to red listed first. A user may select a number of policies by ticking boxes 803 and then compare them by clicking link 804. This will lead the user back to webpage 501 shown in FIG. 5.

It is possible that not all of the features or pitfalls found in a policy are relevant to a user, or that some are particularly relevant. For example, a policy may contain a very high excess for persons under a particular age. This would be marked as a pitfall, but it would not be a problem to a user over that age. Alternatively, the user may need cover for driving in a foreign country for at least a month, which means that two weeks' foreign cover, although marked as a feature, would not be helpful, while a policy without foreign cover at all should be ranked very low. Thus in an embodiment where the text of the policy is automatically parsed it is possible for the user to specify further analysis rules at step 309, either to ignore certain features or to particularly search for them. This could completely change the rankings of the policies.

Additionally, if a logged-in user enters personal details at step 305 it is possible for an online search to be made of available policies. The price of the policy, the available extras (such as protected no-claims bonus or legal cover) and the excess can be used to modify the score of a policy. In a further embodiment, the user could indicate how important each element of a score is to him. For example, he may wish to rank policies mainly on price, but with the green-red ratio modifying the score slightly, or the quality of service shown by the green-red ratio may be just as important as the price. The user could be invited to rank a number of options in order, or there could be a slider that indicates a position between “unimportant” and “important”, and so on. Such an interface could also be used for the further analysis rules specified at step 309.

What is claimed is:

1. A method of analysing a document, comprising the steps of:
receiving and storing the text of a document;
analysing the document according to predetermined rules to identify pitfalls and features of the document; and
creating and displaying a graphic displaying the pitfalls and features.

2. A method according to claim 1, wherein the graphic is an image of the textual layout of the document with sections identified as pitfalls shaded in a first colour and sections identified as features shaded in a second colour.

3. A method according to claim 2, wherein said graphic further includes the text of the document.

4. A method according to claim 1, wherein said analysis further includes the step of determining a score for the document, and the graphic is a graph illustrating the score.

5. A method according to claim 4, wherein the score is the ratio of the number of sections identified as features to the number of sections identified as pitfalls.

6. A method according to claim 4, wherein the score is the ratio of the number of words in sections identified as features to the number of words in sections identified as pitfalls.

7. A method according to claim 1, further including the steps of:
receiving and storing user indications of certain features and pitfalls that are to be ignored or searched for within the text; and
altering the predetermined rules according to the user indications.

8. A method according to claim 1, wherein the document is a policy document for an insurance policy, and further including the steps of:
receiving and storing user details;
obtaining and storing a quote for the insurance policy based on said user details; and
determining and displaying a score for the insurance policy based on the analysis of the document and the quote.

9. A method according to claim 8, further including the steps of:
receiving and storing user indications of the importance of elements of the score; and
determining a modified score based on the analysis of the document, the quote and the user indications.

10. A method according to claim 1, wherein said graphic is displayed via a website.

11. Apparatus for analysing a document comprising a processor, storage, memory and a network connection, wherein said processor is configured to:
analyse a document according to predetermined rules to identify pitfalls and features of said document,
create a graphic displaying said pitfalls and features, and
send said graphic to a networked computer for display on said computer.
